(19) United States
(12) Patent Application Publication
(10) Pub. No.: US 2023/0196490 A1
(43) Pub. Date: Jun. 22, 2023

(54) COMPUTER SYSTEM FOR PROVISION OF EMERGENCY EQUIPMENT

(71) Applicant: International Business Machines Corporation, Armonk, NY (US)

(72) Inventors: Hemant Kumar Sivaswamy, Pune (IN); Kiruthikalakshmi Periasamy, Erode (IN); Venkata Vara Prasad Karri, Visakhapatnam (IN); Shikhar Kwatra, San Jose, CA (US)

(21) Appl. No.: 17/644,841

(22) Filed: Dec. 17, 2021

(51) Int. Cl. G06Q 50/26; G06Q 10/08; B64D 1/02; B64D 1/22; B64C 39/02

(52) U.S. Cl. CPC G06Q 50/265; B64C 39/024; B64D 1/02; B64D 1/22; G06Q 10/087; G06Q 10/0832; B64C 2201/128

(57) ABSTRACT

Using machine logic (for example artificial intelligence (AI) software) to assemble emergency equipment during an emergency, with the help of UAVs for transport. Also, using machine logic to design purpose built emergency equipment during an emergency.

### BACKGROUND

The present invention relates generally to the field of providing emergency equipment in an emergency situation (for example, providing a raft to people trapped in a flood or providing parachutes and safety helmets to people trapped at the top of a tall burning building).

U.S. Pat. Application Publication US 2021/0192629 (“Tofte”) states, in part, as follows: “In some aspects, central monitoring system may function automatically or semiautomatically with no user intervention or minimal user intervention, respectively. For example, central monitoring system may be implemented ... to command, control, and/or communicate with one or more UAVs ... Cargo bay may be configured to provide storage space for UAV. As will be further discussed below, UAV may deliver, distribute, and/or drop various objects in various aspects.... To provide another example, the collected [UAV] data may be processed by ... computing device (e.g., central monitoring system) and result in UAV independently executing and/or receiving a command that causes UAV to execute one or more actions to prevent, control, and/or mitigate damage caused by a catastrophe ... Additionally, or alternatively, one or more UAVs may deliver survival kits or other assistance (e.g., lighting) to people in a catastrophe situation. Survival kits may include necessary life prolonging items such as blankets, food, flashlights, medical supplies, water, first aid supplies, bandages, parachutes, zip lines, rope, sutures, a camera to facilitate the insured taking pictures of a damaged insured asset, etc. Since multiple UAVs may carry more than one survival kit, in the event of a catastrophe, a number of UAVs may be dispatched to quickly canvass an entire area proximate to the catastrophe, quickly disbursing supplies to those who need them while emergency response personnel continue with their rescue operations.” (drawing reference numerals)

U.S. Pat. Application Publication US 2021/0192629 (“Tofte”) states, in part, as follows: “Computers are frequently formed into networks, and networks of computers may be referred to here by the term ‘computing machine’. In one instance, informal internet networks known in the art as “cloud computing” may be used to assist in deploying arrays of unmanned aerial vehicles ... for search-and-rescue operations.... Array operations may be conducted in flight and hover mode, and may be continued at the designated target site after the vehicles land. Array operations may include sensing and transmission functions under remote monitoring and control. These operations generally include collection of sensor data, but also may include ... rescue, delivery of supplies . . .”

### SUMMARY

According to an aspect of the present invention, there is a method, computer program product and/or system that performs the following operations (not necessarily in the following order): (i) receiving an inventory data set that includes a plurality of items residing at a plurality of residences and/or businesses in a local area; and (ii) while a large scale emergency event is imminent and/or occurring in the local area: (a) receiving an emergency event data set that includes information indicative of the nature and magnitude of the large scale emergency event and respective locations of a plurality people in in need of rescue from the large scale emergency event, with the plurality of people including a first person, (b) determining, by machine logic, a first item of the plurality of items that would be useful to the first person with respect to rescue of the first person, and (c) controlling, by machine logic, a first unmanned aerial vehicle to: (i) pick up the first item at its location at a residence or business in the local area as indicated by the inventory data set, and (ii) deliver the first item to the first person as indicated by the emergency event data set.

### BRIEF DESCRIPTION OF THE DRAWINGS

FIG. 1 is a block diagram of a first embodiment of a system according to the present invention;

FIG. 2 is a flowchart showing a first embodiment method performed, at least in part, by the first embodiment system; and

FIG. 3 is a block diagram showing a machine logic (for example, software) portion of the first embodiment system.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer’s non-volatile storage and partially stored in a set of semiconductor switches in the computer’s volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

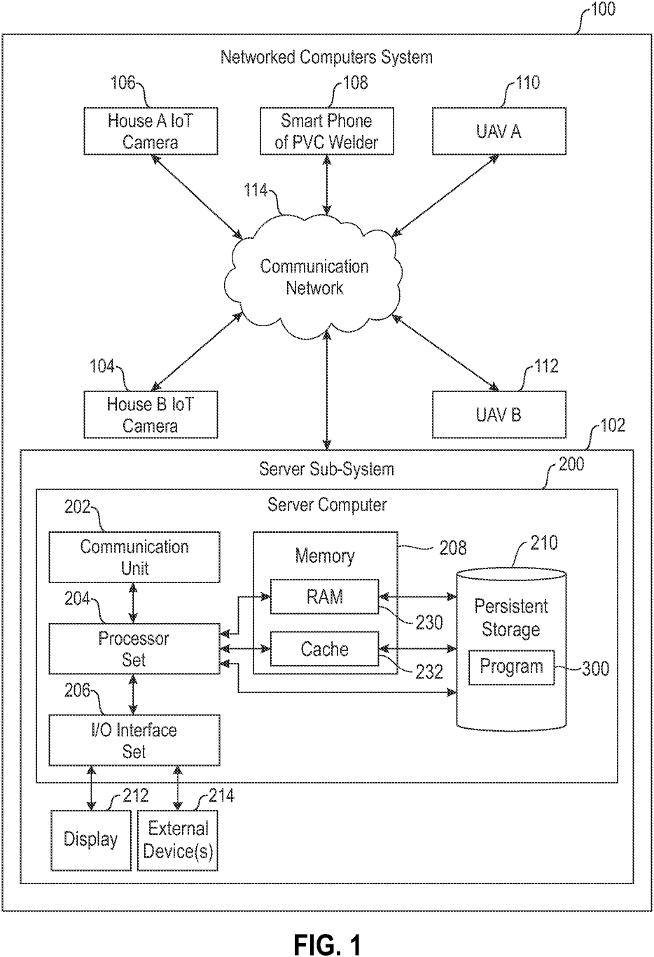

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); house B IoT (internet of things) camera 104; house A IoT camera 106; smart phone of PVC (polyvinyl chloride) welder 108; UAV (unmanned aerial vehicle) A 110; UAV B 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

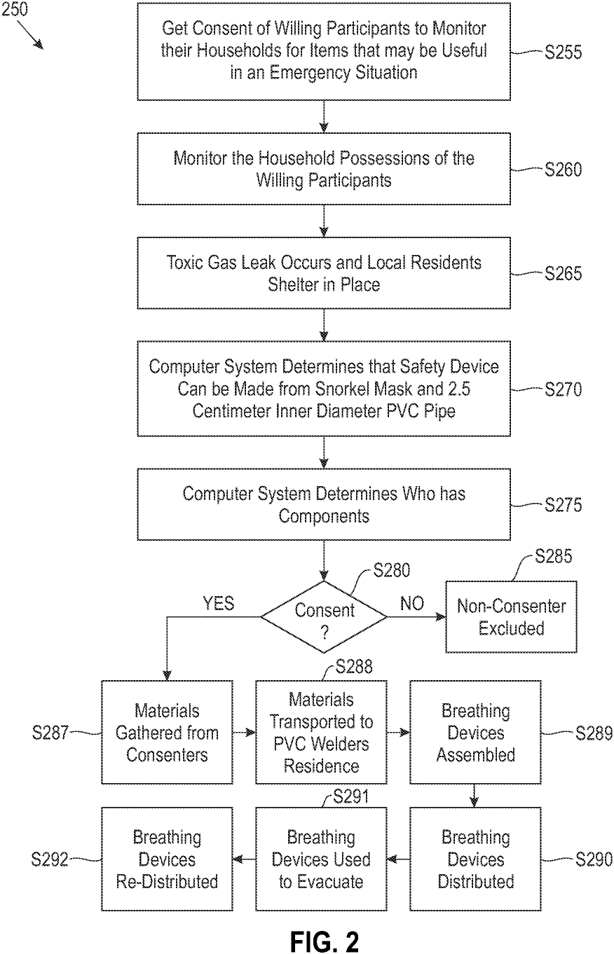

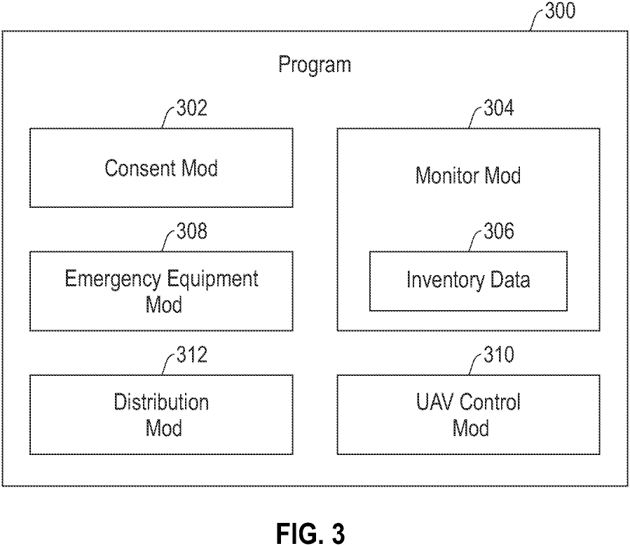

As shown in FIG. 1, networked computers system 100 is an environment in which an example method according to the present invention can be performed. As shown in FIG. 2, flowchart 250 shows an example method according to the present invention. As shown in FIG. 3, program 300 performs or control performance of at least some of the method operations of flowchart 250. This method and associated software will now be discussed, over the course of the following paragraphs, with extensive reference to the blocks of FIGS. 1, 2 and 3.

Processing begins at operation S255, where consent module (“mod”) 302 gets consent to install internet of things (IoT) monitoring equipment in many houses in a local area. More specifically, this local area is a fertile valley with many residences and several factories including a PVC pipe factory and a chemical factory. The area surrounding the valley is sparse populated and relatively difficult to reach from major urban areas. The consent to the IoT household monitoring is obtained when people in the valley enroll in a disaster relief program. The monitoring involves a sacrifice of some privacy, but the idea is that this sacrifice could become worthwhile when an emergency occurs, as will become evident as discussion steps through the flow chart of FIG. 2. FIG. 1 shows representative IoT monitoring equipment, specifically house B IoT camera 104 and house A IoT camera 106. The chemical factory and the PVC pipe factory also enroll in the disaster relief program, but they are very careful not to allow the IoT monitoring equipment to be placed in locations where trade secrets could be revealed.

Processing proceeds to operation S260, where monitor mod 304 controls and directs the monitoring equipment (for example, 104 and 106) to monitor the participating households and businesses to determine items going into and out of the houses and local businesses. Inventory data 306 is created and maintained dynamically over time as items are acquired and consumed and/or discarded.

Processing proceeds to operation S265, when an emergency situation occurs. In this emergency situation, water has gotten into one of the chemical tanks at the chemical plant. Pressure and temperature start to build in the tank and an explosion is imminent. Because of the IoT monitoring at the chemical plant, the remedial actions of the present invention can begin before the tank has even exploded.

Processing proceeds to operation S270, where emergency equipment mod 308 analyzes the emerging emergency situation. In this example, mod 308 determines that after the explosion happens: (i) toxic gas will be dispersed through the valley when the tank explodes; (ii) the gas will cause acute respiratory distress and damage to the eyes; and (iii) because of temperature and pressure conditions in the valley, the toxic gas will be at dangerous concentrations up to a height of 8 feet above the entire valley floor. This shows how the power of artificial intelligence (AI) can figure out important-to-know aspects of the emergency situations much more quickly than human individuals can be expected to - this is an important potential advantage because, in many emergency situations, time is of the essence.

Processing proceeds to operation S275, where the machine logic of mod 308 determines what emergency equipment may be useful in order to save people from the impending toxic gas leak emergency. In this example, one thing that mod 308 determines is that there are not nearly enough gas masks in the vicinity for all the people in the valley. In this example, it is determined that the nearest gas masks, gas cylinders and heavy unmanned aerial vehicles will not be able to be deployed in time to save the people of the valley. Another thing it determines is that there is a small fleet of busses that are relatively airtight, such that, if an individual can make it to a bus, then the individual can escape the gas leak. Unfortunately, people will have to get to the busses as they shuttle people out, and it is likely that most will perish when trying to get from their residence to a shuttle bus.

At operation S275, mod 308 also determines that emergency devices can be made to get people from their residences and workplaces to the shuttle busses. More specifically, in this example (which is pedagogical for purposes of explaining the present invention and not to be taken as actual emergency advice), if a 10 feet length of 2.5 centimeter inner diameter PVC pipe is welded to the breathing tube of a standard swimming snorkel, then an individual’s eyes and lungs will be protected from the low lying impending toxic gas leak. Discussion will pause here to note that, in this example, the emergency devices are not something that human individuals could conceive of quickly enough to be useful in the emergency. Once again, the AI is leveraged to figure out an approach that is not readily available on modern crowdsourced information services, like Wikipedia and YouTube.

Mod 308, by consulting inventory data 306, further determines that: (i) the PVC pipe factory has a great many PVC pipes of the appropriate length and inner diameter; (ii) many participating households have appropriate swimming snorkels; and (iii) no participating individuals have appropriate PVC welding equipment to perform the necessary PVC welding. However, with regard to the problem posed by item (iii), mod 308 consults publicly available records and determines contact information for a retired PVC welder who lives on a hilltop overlooking the valley. This hilltop is outside of the potential danger zone due to its high elevation.

While the computations of the previous three paragraphs is going on, the tank at the chemical factory does explode and disperses toxic gas, exactly as predicted. The local authorities give a shelter in place order for everyone in the surrounding area in a timely fashion. In this example, the shelter in place order will provide good protection for a limited time.

Processing proceeds to operation S280 where consent mod 302 requests consent from parties to provide materials and/or services to construct the snorkel/pipe emergency devices. It is important to understand the importance of consent here. In an emergency situation, the self-preservation instinct that many humans have will cause them to tend to want to hang on to their obvious emergency supplies (for example, medicines, gas masks, generators, large floating objects). Even if they agreed to relinquish these items when they enrolled in the disaster relief program at operation S255, many people might want to withdraw their consent at the time the emergency happens. It is critically important to respect the concept of consent and the concept of withdrawal of consent. Among other things, a like of consent may cause people to interfere with the people and/or UAVs that come to collect emergency materials. For this reason, consent is required after the emergency has started and immediately before any materials are taken away. This may not be critical from a technology perspective, but it is critical from a societal perspective. Three different types of consent will be discussed in the following three paragraphs.

In this example, consent to provide PVC welding services is first obtained from the welder on the hilltop. Consent mod 302 explains the situation to the welder through smart phone of PVC welder 108. The welder is indeed amenable to perform the welding operations, especially once they are informed that they are well out of the danger zone that is spreading across the floor of the valley below. The welder has good welding equipment and sufficient fuel to make many snorkel/pipes very quickly.

Contemporaneous consent operation S275 proceeds to request consent from the PVC pipe factory. They provide such consent readily and eagerly. They will give as many pipes as the disaster relief program can take. Not only is it the right thing to do in a moral sense, but it also seems like an opportunity for good public relations. On a related note, if the PVC pipe factory refused consent, then that refusal must be kept confidential. Otherwise, business might not enroll in the disaster relief program in the future.

Contemporaneous consent operation S275 proceeds to ask participating households for permission to collect their snorkels. It is explained that these will be welded to long pipes to provide protection from the creeping toxic gas. Some readily give consent. That is understandable, in this example, because the snorkel is not likely to be of much use without the PVC pipe component and the services of the PVC welder who lives on the hilltop. On the other hand, some refuse. Some of these refusals occur because the snorkel owner thinks that they may be able to pull PVC pipe out of their walls to jerry-rig an effective snorkel pipe device and use it to get to the shuttle busses that have now started running. This hypothetical example will leave the reader to imagine whether these refusers perish or survive the gas leak. For those who do refuse, processing proceeds to operation S285, where the refusers are excluded from further participation in the disaster relief program. This is not done to punish the refusers, of course, but rather because these individuals are more likely to interfere with any people and or UAVs sent to their households by the disaster relief program.

For the consenters, on the other hand, processing proceeds to operation S287, S288 S289 and S290 where distribution mod 312 and UAV control mod 310 control a dedicated fleet of UAVs (see UAV A 110 and UAV B112) to perform the following distributive actions: (i) collect pipes from the pipe factory (see operation S287) and fly them up the hill to the home of the PVC welder (see operation S288); (ii) collect snorkels from the participating households of the consenters and fly them up the hill to the home of the PVC welder; and (iii) after assembly of the snorkel/pipe assemblies (see operation S289), to fly those back down the hill to the households of the valley (see operation S290). In this example, participating households who provide snorkels are given priority over participating household that had no snorkels to give, and participating households are given priority over households that participate in the disaster relief program. This distribution scheme provides incentive for households to participate in the disaster relief program.

Processing proceeds to operation S291, where those who receive the assembled emergency equipment proceed to use the equipment to run to shuttle busses with the snorkel masks pressed firmly against their faces to avoid damage from the toxic gas which has now formed a visible ground level fog, as predicted, over the whole floor of the valley. Everyone who gets the emergency equipment is successfully rescued, in this hypothetical example.

Processing proceeds to operation S292, where mods UAVs that follow the shuttle busses collect the emergency equipment from onboarding passengers and re-distribute them to those still sheltering in place.

### III. Further Comments and /or Embodiments

A first scenario in which the present invention is used will now be discussed. Every house might have some unique item in store. example house A might have a powerful torch, House B might have a generator set, House C might have a lifebuoy, house D might have a big tub. When a flood happens, people may be unaware to all the residents in an area. Each of the houses might have an item not known to each other while collectively it could serve a purpose to tackle the problem. This is when the IoT devices in each of these house aggregate. When the flood rises, the UAV which has the details of each of the house help to communicate with each of the houses and collate the items needed collectively to rescue each of the house members one by one. In scenario 1- house A will have rope, house B will have bamboo logs, house 3 will have thick plastic sheet. The IoT devices collated each of these items among many other items. Using image analysis and a learning algorithm and from a corpus database, there will be several ways of making a raft. In this case, using rope, bamboo and plastic sheet we can make a small boat. The 3 items will be identified among a plurality of other existing items and aggregated from 3 or more houses. The AI module ingests the information from the database and identifies the most suitable items needed to make a rescue raft. DISCLAIMER: any item(s) should only be taken from a house if the owner of the house and the owner of the item(s) consent contemporaneously with the taking of the item(s) - commandeering private property without clear and contemporaneous consent is not appropriate and may also be illegal.

A second scenario in which the present invention is used will now be discussed. When the items (daily commodities) of each of the houses deplete or about to be depleted. During flood affected times in a street people cannot travel out, the IoT collates these items and based on priority of each of the houses, the UAVs aggregate and distribute among the houses. Thus, as a team all of the houses get enough quantity to run for a period. DISCLAIMER: any item(s) should only be taken from a business or warehouse if the owner of the warehouse and the owner of the item(s) consent contemporaneously with the taking of the item(s) - commandeering private property without clear and contemporaneous consent is not appropriate and may also be illegal.

A second scenario in which the present invention is used will now be discussed. In the scenarios of the previous two paragraphs, based on the aggregating job performed, the UAV(s) report what kind of help or supplies (relief materials like food, medicines and so on) are needed immediately from the first responders in an area on an hourly basis. This will help to focus on what is needed area-wise and even house-wise during such disasters thereby enhancing the effectiveness of first responders. Because the people may not actually be aware, a scientific proven method using existing technology should help the community be informed of the step-by-step preparation one should do.

Some embodiments of the present invention may include one, or more, of the following operations, features, characteristics and/or advantages: (i) identifies the items from a plurality of items based on the specific context (may be flood, earthquake); (ii) example, a normal user may not know what items might be needed to make an emergency boat, but the UAV which aggregates knows that it needs rope from House A, bamboo from B, and so on, based on the corpus it has already identified and stored; (iii) registers IoT or smart devices available at each household along with the resident or user information, to create a repository of any objects available at the household; (iv) this data is crucial for the UAVs in delta computation and decision making that render survival easier until an evacuation or other relief operations happens; (v) gathering information of any house-hold supplies, including groceries at any house though registered IoT or smart devices; (vi) an item needed in house A may not be used or needed at all in house B or it could serve as a potential raw material to create an apparatus for rescue; (vii) based upon such analysis, the UAV aggregates and maintains records of available items at any point in time around that locality. DISCLAIMER: any tracking and/or monitoring by IoT and/or smart devices in each household should only be clear consent from all who reside in the household - monitoring the inside of residences is generally not appropriate, absent clear consent by all involved, and may also be illegal.

Some embodiments of the present invention may include one, or more, of the following operations, features, characteristics and/or advantages: (i) determines and triggers a UAV or a swarm of UAVs based on the commodities supply based handshake algorithm; (ii) if there are dictionary records with low or nil supply of commodities in an area or house, and if the current UAV is already on the job it will trigger additional UAV(s) for specific needs that are detected; and/or (iii) capable of forming a UAV network anywhere when there is a need.

A method according to an embodiment of the present invention includes the following operations (not necessarily in the following order): (i) identify, aggregate and update emergency items to a repository using contextual IoT devices; (ii) aggregate them with a UAV to enable unrelated/unknown people living close by (that is, only people who contemporaneously consent to the plan) based on predictive township needs and delta computation; (iii) computing delta is computed via audio and usage of image analytics to identify and classify objects ‘specific to an emergency’ based on a data dictionary with the details already available; and (iv) identifying and clustering items relevant to the context during an emergency by segregating the essentials versus non-essential to arrive at creating a rescue item.

As an example of the method outlined in the previous paragraph, collating and creating a raft out of multiple raw materials (rope, bamboo and so on) obtained from different sources/houses during a flood. People are disconnected during such disasters; the system helps to collate information and items from disparate sources and help make rescue items on the fly. Helpful during a flood when an item needed by a person may be available at a residence a few houses away or may be a combination of raw materials needed to create a rescue dinghy like boat.

Some embodiments of the present invention may include one, or more, of the following operations, features, characteristics and/or advantages: (i) after clear and informed consent with respect to such monitoring, a user registers the smart devices like refrigerator, microwave, smart cameras to the repository holding information about those devices inclusive of user’s public information and device ID’s associated with the devices; (ii) a database will have a corpus of many different techniques of making rescue items for flood, fire, earthquake like emergencies; (iii) each of these techniques could be uniquely different with different solutions for the same problem; and/or (iv) example, using raw materials like bamboo + rope + thick plastic sheets, one can make a raft.

Some embodiments of the present invention may include one, or more, of the following operations, features, characteristics and/or advantages: (i) identification of most relevant substitute items or combinations of disparate substitute items using semi-supervised learning for creating makeshift rescue items instructed through machine logic implemented through UAVs; (ii) based on the items aggregated using contextual IoT devices to a common repository, the identified relevant and substitute items most relevant to the context are identified where the system communicates from the repository to the houses using a fleet of UAVs; (iii) the UAV helps to communicate to each of the houses and will help to describe and instruct how to make a rescue item/tool (for example, a makeshift raft) with the items very specific to the raw items that the household has in the vicinity of the emergency situation and already have on hand; (iv) this is from the AI system which, after using semi supervised learning, knows the various items needed to make a raft; (v) so, a combination of items can be worked by the AI system here tailor made to the context and availability of raw materials at each of the houses; (v) the AI system will also dynamically derive a script based on the different types of substitute materials available in the locality and using natural language parsing to make sentences and dictate using a UAV; (vi) the AI system using AI Image Analytics from the corpus database identify and segregate the items among other irrelevant items which will be suitable for a disaster; (vii) people tend to be disconnected during such disasters, the system helps to collate information and items from disparate sources and help make rescue items on the fly helpful during flood when an item needed by a person may be available at a residence a few houses away or may be a combination of raw materials needed to create a rescue dinghy like a boat; (viii) a normal person may not be aware how to make a rescue boat out of substitute items or an emergency ladder out of different pieces of wood, PVC pipe pieces and rope/cloth.

In another scenario where the technology of the present invention may be helpfully applied, a method which could collectively serve a purpose to tackle the problem, every house might have some unique item in store. example house A might have a powerful torch, House B might have a generator set, House C might have a lifebuoy, house D might have a big tub. When a flood happens, people are unaware to all the residents in an area. Each of the houses might have an item not known to each other while collectively it could serve a purpose to tackle the problem. This is when the IoT devices in each of the house aggregate. When the flood rises the UAV which has the details of each of the houses helps to communicate with each of the houses and collate the items needed collectively to rescue each of the house members one by one.

In another scenario, house A will have rope, house B will have bamboo logs, house 3 will have thick plastic sheet. The IoT devices has collated each of these items among many other items. Using image analysis and a learning algorithm and from a corpus database there will be several ways of making a raft. In this case, using rope, bamboo and plastic sheet we can make a small boat. The 3 items will be identified among a plurality of other existing items and aggregated from 3 or more houses. The AI module ingests the information from the database and identifies the most suitable items needed to make a rescue raft.

In another scenario, if all of these items are available in a single house and yet the person dwelling in that house does not either realize these items can be used to make a useful rescue boat or may not know how to make it. So, the AI module which lies on top of the data which has the items already identified using contextual IoT devices like a smart camera, Alexa is trained using semi supervised learning. The AI system understands that empty PVC pipes, loose bamboos, wooden logs can be used and using a nylon rope can be tied together to create a makeshift raft. The method to make this is available in the repository. The UAVs are used to project on the walls using a video projector or using voice command in multilingual suiting to the local language of the people to give a step by step instruction to make the boat.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above - similar cautions apply to the term “embodiment.”

And/or: inclusive or; for example, A, B “and/or” C means that at least one of A or B or C is true and applicable.

Including / include / includes: unless otherwise explicitly noted, means “including but not necessarily limited to.”

Module / Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

Virtualized computing environments (VCEs): VCEs can be stored as “images.” A new active instance of the VCE can be instantiated from the image. Two types of VCEs are virtual machines and containers. A container is a VCE that uses operating-system-level virtualization. This refers to an operating system feature in which the kernel allows the existence of multiple isolated user-space instances, called containers. This isolated user-space instances may look like real computers from the point of view of programs running in them. A computer program running on an ordinary operating system can see all resources (connected devices, files and folders, network shares, CPU power, quantifiable hardware capabilities) of that computer. However, programs running inside a container can only see the container’s contents and devices assigned to the container.

Cloud computing system: a computer system that is distributed over the geographical range of a communication network(s), where the computing work and/or computing resources on the server side are primarily (or entirely) implemented by VCEs (see definition of VCEs in previous paragraph). Cloud computing systems typically include a cloud orchestration module, layer and/or program that manages and controls the VCEs on the server side with respect to instantiations, configurations, movements between physical host devices, terminations of previously active VCEs and the like.

What is claimed is:

1. A computer-implemented method (CIM) comprising:
receiving an inventory data set that includes a plurality of items residing at a plurality of residences and/or businesses in a local area; and
while a large scale emergency event is imminent and/or occurring in the local area:
receiving an emergency event data set that includes information indicative of the nature and magnitude of the large scale emergency event and respective locations of a plurality people in in need of rescue from the large scale emergency event, with the plurality of people including a first person,
determining, by machine logic, a first item of the plurality of items that would be useful to the first person with respect to rescue of the first person, and
controlling, by machine logic, a first unmanned aerial vehicle to: (i) pick up the first item at its location at a residence or business in the local area as indicated by the inventory data set, and (ii) deliver the first item to the first person as indicated by the emergency event data set.

2. The CIM of claim 1 further comprising:
immediately prior to controlling the UAV to pick up the first item, obtaining informed consent from an owner of the first residence.

3. The CIM of claim 1 wherein the first item is useful to the first person as a component in a larger assembly that is useful for rescuing people in the local area from the large scale emergency event, with the larger assembly including a plurality of components, which includes a first component corresponding to the first item.

4. The CIM of claim 3 further comprising:
designing, by machine logic, the larger assembly; and
communicating, to the first person, the design of the larger assembly.

5. The CIM of claim 3 further comprising:
controlling UAV(s) to deliver all components of the larger assembly to the first person.

6. The CIM of claim 1 wherein:
the large scale emergency event impacts at least 100 residences and/or businesses; and
the large scale emergency event is one of the following: a natural disaster or an accidental disaster created by humans.

7. A computer program product (CPP) comprising:
a set of storage device(s); and
computer code stored collectively in the set of storage device(s), with the computer code including data and instructions to cause a processor(s) set to perform at least the following operations:
receiving an inventory data set that includes a plurality of items residing at a plurality of residences and/or businesses in a local area; and
while a large scale emergency event is imminent and/or occurring in the local area:
receiving an emergency event data set that includes information indicative of the nature and magnitude of the large scale emergency event and respective locations of a plurality people in in need of rescue from the large scale emergency event, with the plurality of people including a first person,
determining, by machine logic, a first item of the plurality of items that would be useful to the first person with respect to rescue of the first person, and
controlling, by machine logic, a first unmanned aerial vehicle to: (i) pick up the first item at its location at a residence or business in the local area as indicated by the inventory data set, and (ii) deliver the first item to the first person as indicated by the emergency event data set.

8. The CPP of claim 7:
immediately prior to controlling the UAV to pick up the first item, obtaining informed consent from an owner of the first residence.

9. The CPP of claim 7 wherein the first item is useful to the first person as a component in a larger assembly that is useful for rescuing people in the local area from the large scale emergency event, with the larger assembly including a plurality of components, which includes a first component corresponding to the first item.

10. The CPP of claim 9 wherein the computer code further includes instructions for causing the processor(s) set to perform the following operation(s):
designing, by machine logic, the larger assembly; and
communicating, to the first person, the design of the larger assembly.

11. The CPP of claim 9 wherein the computer code further includes instructions for causing the processor(s) set to perform the following operation(s):
controlling UAV(s) to deliver all components of the larger assembly to the first person.

12. The CPP of claim 7 wherein:
the large scale emergency event impacts at least 100 residences and/or businesses; and
the large scale emergency event is one of the following: a natural disaster or an accidental disaster created by humans.

13. A computer system (CS) comprising:
a processor(s) set;
a set of storage device(s); and
computer code stored collectively in the set of storage device(s), with the computer code including data and instructions to cause the processor(s) set to perform at least the following operations:
receiving an inventory data set that includes a plurality of items residing at a plurality of residences and/or businesses in a local area; and
while a large scale emergency event is imminent and/or occurring in the local area:
receiving an emergency event data set that includes information indicative of the nature and magnitude of the large scale emergency event and respective locations of a plurality people in in need of rescue from the large scale emergency event, with the plurality of people including a first person,
determining, by machine logic, a first item of the plurality of items that would be useful to the first person with respect to rescue of the first person, and
controlling, by machine logic, a first unmanned aerial vehicle to: (i) pick up the first item at its location at a residence or business in the local area as indicated by the inventory data set, and (ii) deliver the first item to the first person as indicated by the emergency event data set.

14. The CS of claim 13:
immediately prior to controlling the UAV to pick up the first item, obtaining informed consent from an owner of the first residence.

15. The CS of claim 13 wherein the first item is useful to the first person as a component in a larger assembly that is useful for rescuing people in the local area from the large scale emergency event, with the larger assembly including a plurality of components, which includes a first component corresponding to the first item.

16. The CS of claim 15 wherein the computer code further includes instructions for causing the processor(s) set to perform the following operation(s):
designing, by machine logic, the larger assembly; and
communicating, to the first person, the design of the larger assembly.

17. The CS of claim 15 wherein the computer code further includes instructions for causing the processor(s) set to perform the following operation(s):
controlling UAV(s) to deliver all components of the larger assembly to the first person.

18. The CS of claim 13 wherein:
the large scale emergency event impacts at least 100 residences and/or businesses; and
the large scale emergency event is one of the following: a natural disaster or an accidental disaster created by humans.
